(19) United States
(12) Patent Application Publication
(10) Pub. No.: US 2004/0182441 A1
(43) Pub. Date: Sep. 23, 2004

(54) Toilet tank fill valve internally sealed with ceramic slices

(76) Inventor: Mary M. Russell, Jeffersonville, IN (US)

Correspondence Address: Mary M. Russell, 1535 Autumn Ridge Court, Apt. 2, Jeffersonville, IN, 47130, US

(21) Appl. No.: 10/390,266

(22) Filed: Mar. 17, 2003

(51) Int. Cl. F16K 31/18

(52) U.S. Cl. 137/424

(57) ABSTRACT

This invention is a kind of toilet tank fill valve internally sealed with ceramic slices. It includes a double layered water passing tube, a float, a sleeve, and a one-way valve. It works independently without a tank ball. It solves water leakage problem completely and has a service life of 50,000 flushes.

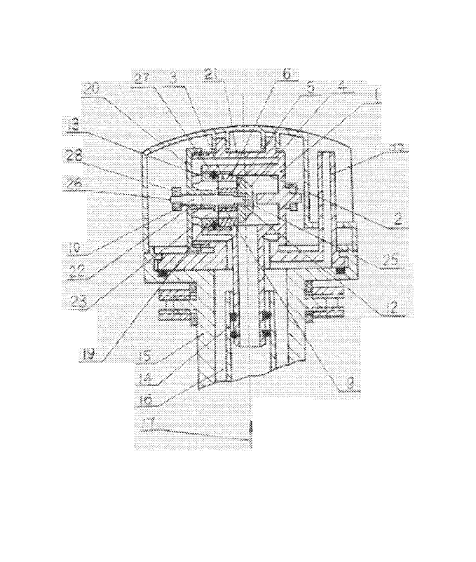

### THE BACKGROUND OF THIS INVENTION

Traditional toilet tank fill valves are internally sealed with rubber plugs. After repeated usage, rubber plugs lose their elasticity and that causes water leakage in most toilet tanks. Instead of utilizing rubber plugs, this invention has two ceramic slices to seal the valve. It works independently without a tank ball. It will solve the water leakage problem completely. The life expectancy for this toilet tank fill valve is 50,000 flushes.

### BRIEF DESCRIPTION OF THE DRAWINGS

(1) valve shell

(2) internal wall

(3) stationary slice

(4) movable slice

(5) protruding platform

(6) rib

(7) notch

(8) fan-shaped hole

(9) round hole

(10) axle

(11) fan-shaped petal

(12) rectangle notch

(13) semicircle hole

(14) interior tube

(15) exterior tube

(16) water passageway

(17) water

(18) tank bottom

(19) cylindrical ring

(20) cover

(21) exterior wall

(22) cylindrical hole

(23) orientation slice

(25) one end of the axle

(26) one end of the axle

(27) o-ring

(28) one end of tank lever

(29) one end of tank lever

(30) float

(31) the top of the float

(32) counterweight

(33) sleeve

(34) one-way valve

(35) refill tube

### DETAILED DESCRIPTION WITH DRAWINGS

1) Inside (2) a double deck cylindrical valve (1), place a pair of ceramic slices (3 & 4) along the axle.

2) The diameter of the stationary slice (3) is bigger than that of the movable slice (4).

3) There is a protruding platform (5) holds the stationary slice (3) and movable slice (4) together.

4) Two ribs (6) are on the protruding platform (5).

5) The stationary slice (3) is placed on the protruding platform (5).

6) The two ribs (6) go into the two notches (7) on the stationary slice (3). Thus, the stationary slice (3) is in position.

7) Several fan-shaped holes (8) are designated on the stationary slice (3) (the quantity of the holes should be 4 to 6). There is a round hole (9) in the center of the stationary slice (3). The diameter of the round hole (9) is bigger than that of the axle (10).

8) Corresponding to the fan-shaped holes (8) on the stationary slice (3), there are as many as fan-shaped petals (11) on the movable slice (4). There is a rectangle notch (12) in the center of the movable slice (4). Water stops filling when fan-shaped holes (8) are covered by fan-shaped petals (11).

9) There is a double layered water tube vertical to the axle on the sealed side of the valve (1). It consists of interior tube (14) and the exterior tube (15), in between there is a water passageway (16). There is an o-ring (27) and a cylindrical ring (19) on the open side of the valve (1). There are a few semicircle holes (13) on one side of the cylindrical ring (19), which is close to the cover (20). Water goes through these semicircle holes (13).

10) The cover (20) and exterior wall (21) are connected with a screw nut. There is a cylindrical hole (22) in the center of the cover (20). It cooperates with axle (10), and supports the rotation of axle. There is an orientation slice (23) on the axle (10). It ensures that the rotation of the axle (10) after the cover (20) is twisted tight.

11) The two ends (25 & 26) of the axle (10) are squat-shaped. One end (25) goes through the round hole (9) and ends in the rectangle notch (12). However, it does not touch the bottom of the rectangle notch (12). The other end (26) goes into cylindrical hole (22). The cover (20) pushes the cylindrical ring (19) and presses the o-ring (27) and stationary slice (3). This will seal the stationary slice (3) and the interior wall (2).

12) After twisting the cover (20) to completion, one end (26) of the axle (10) comes out of the cover (20) and goes into the rectangle notch (12) on the end (28) of the tank lever. The other end (29) of the tank lever and the top of the float (31) have sliding cooperation. There is a counterweight (32) in the float (30).

13) The float (30) is placed inside the sleeve (33). There is a one way valve (34) on the bottom of the sleeve (33), and it only allows water to flow out. The sleeve (33) and the external tube (15) are connected with a screw nut.

14) When the tank water level goes down to the bottom of the sleeve (33), the moment of gravity produced by counterweight (32) overcomes the moment of frictional force produced by the water pressure. It forces the axle (10) to rotate and the movable slice (4) to rotate in the same direction. Therefore, the fan-shaped petals (11) and the fan-shaped holes (8) stagger, and the water goes into the tank bottom (18) through The interior tube (14), movable slice (4), fan-shaped holes (8), semicircle hole (13), and the water passageway (16).

15) When the water level goes up to the tope of the sleeve (33), water will flow into the sleeve (33) and produce buoyancy. The moment of buoyancy overcomes both the moment of frictional force produced by the water pressure and the moment of gravity produced by the counterweight (32). As a result, the float (30) will move rapidly, and the axle (10) will rotate and the movable slice (4) will rotate in the opposite direction. The fan-shaped petals (11) will overlap the fan-shaped holes (8) completely. Then the water will stop flowing. The space between axle (10) and cylindrical hole (22) have anti-siphon function.

### DETAILED DESCRIPTION

In a double deck cylindrical valve, place a pair of ceramic slices along the axle. The smoothness and roughness of the two slices are the same as regular ceramic slices found in water faucets. One of the slices is placed according to a designed angle, so it is called the stationary slice. The other slice rotates along with the axle, so it is called the movable slice.

Several fan-shaped holes are on the stationary slice for the water to exit. The axle goes through the center hole of the stationary slice. The stationary slice's diameter is bigger than that of the axle's.

The movable slice is platform shaped. The diameter of the movable slice is smaller than that of the interior wall, so the movable slice will not touch the interior wall when it rotates.

Corresponding to the fan-shaped holes on the stationary slice, there are several fan-shaped petals on the movable slice. There is a rectangle notch in the center of the movable slice. This notch is for the axle. When the fan-shaped holes and fan-shaped petals overlap, water will stop flowing.

One side of the valve is sealed and the other side is open. On the sealed side, there is a double layered tube that the water passes through. It is vertical to the axle. The tube is both internal and external. Water enters the internal part of the tube, and flows through the passageway to the bottom of the toilet tank. On the open side of the valve, an o-ring and a cylindrical ring are placed along the interior wall. There is a cover connected with the external wall by a screw nut. A cylindrical hole is in the center of this cover. The cylindrical hole cooperates with the axle to support the axle's rotation.

Both ends of the axle are squat-shaped. One end goes through the round hole in the center of the stationary slice and ends in the rectangle notch in the movable slice. The other end goes through the cylindrical hole in the cover.

When the cover is twisting, the cover pushes the cylindrical ring to press the o-ring and the stationary slice. So the stationary slice is sealed with the interior wall. After its sealing, the end of the axle extends out of the cover and goes into the rectangle hole on the tank lever.

There is a counterweight to the float. The float is inside a sleeve, and there is a one-way valve on the bottom of the sleeve. This valve allows water to only flow out. The sleeve is connected with the external tube with a screw nut.

What I claim as my invention is:

1. A kind of toilet tank fill valve internally sealed with ceramic slices. It includes a double layer water passing tube, a float, a sleeve, and a one-way valve. Inside a double deck cylindrical valve, a ceramic stationary slice is placed according to a designed angle. One end of the axle goes through the center of this ceramic slice and goes into a rectangle notch in a ceramic movable slice. When the cover is twisted to a completion, one end of the axle goes into the rectangle notch on one end of the tank lever. There is a counterweight in the float.
